(19) United States
(12) Patent Application Publication
(10) Pub. No.: US 2025/0158700 A1
(43) Pub. Date: May 15, 2025

(54) PER-PACKET AMPLIFY AND FORWARD RELAY FOR BEYOND IEEE 802.11BE WIRELESS LANS

(71) Applicant: NEWRACOM, Inc., Irvine, CA (US)

(72) Inventors: Il-Gu LEE, Seoul (KR); Joonsoo LEE, Seoul (KR); Si-Chan NOH, Seoul (KR); Heejung YU, Daejeon (KR)

(73) Assignee: NEWRACOM, Inc., Irvine, CA (US)

(21) Appl. No.: 18/941,898

(22) Filed: Nov. 8, 2024

Related U.S. Application Data
(60) Provisional application No. 63/598,503, filed on Nov. 13, 2023.

(51) Int. Cl. H04B 7/155; H04W 84/12

(52) U.S. Cl. CPC H04B 7/15528; H04W 84/12

(57) ABSTRACT

An embodiment is a method performed by a source node to activate relay functionality of a relay node on a per-physical layer protocol data unit (PPDU) basis. The method includes generating a PPDU that includes a first set of preamble fields, followed by a relay-on field indicating that the relay node should relay the PPDU, followed by a second set of preamble fields, followed by a data field that includes a frame intended for a destination node, wherein the first set of preamble fields includes a first legacy short training field (L-STF) field, a first legacy long training field (L-LTF) field, and a first legacy signal (L-SIG) field, wherein the second set of preamble fields includes a second L-STF field, a second L-LTF field, and a second L-SIG field. The method further includes transmitting the PPDU.

### CROSS-REFERENCE TO RELATED APPLICATION

This application claims the benefit of U.S. Provisional Application No. 63/598,503 filed Nov. 13, 2023, titled, “Per-Packet Amplify and Forward Relay for beyond IEEE 802.11be wireless LANs,” which is hereby incorporated by reference.

### TECHNICAL FIELD

The present disclosure generally relates to wireless communications, and more specifically, relates to activating relay functionality of a relay node on a per physical layer protocol data unit (PPDU) basis.

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHZ, 6 GHZ, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

IEEE 802.11be, also known as “Wi-Fi 7”, is the next generation of the IEEE 802.11 family of standards for wireless local area networks. Currently under development, 802.11be aims to significantly improve upon the capabilities of its predecessor, 802.11ax/Wi-Fi 6, by offering even higher data rates, lower latency, and increased reliability. The standard is expected to leverage advanced technologies such as multi-link operation (MLO), which allows devices to simultaneously use multiple frequency bands and channels for enhanced performance and reliability. Additionally, 802.11be will introduce 4096-QAM (Quadrature Amplitude Modulation), enabling higher data rates by encoding more bits per symbol. The standard will also feature improved medium access control (MAC) efficiency, enhanced power saving capabilities, and better support for high-density environments. With these advancements, 802.11be is expected to deliver theoretical maximum data rates of up to 46 gigabits per second (Gbps), making it suitable for bandwidth-intensive applications such as virtual and augmented reality, 8K video streaming, and high-performance gaming. The IEEE 802.11be standard is projected to be finalized by the end of 2024, paving the way for the next generation of Wi-Fi devices and networks.

The IEEE 802.11bn (Ultra High Reliability, UHR) working group has been established with the aim of improving reliability, throughput, latency, and energy efficiency in wireless networks. Relay technology is being considered as a candidate technology to help improve the rate vs. range performance in future wireless networks. There are two types of relay mechanisms. One is a decode-and-forward (DF) relay mechanism and the other is an amplify-and-forward (AF) relay mechanism. With the DF relay mechanism, a relay node decodes, re-encodes, and forwards the received signal to the destination node. With the AF relay mechanism, a relay node amplifies and retransmits the received signal to the destination node without decoding the signal. The AF relay mechanism has at least the following benefits compared to the DF relay mechanism: lower computational cost and lower latency for data exchange.

There are several challenges that need to be addressed when applying relay technology in a conventional wireless network. These challenges include end-to-end channel reservation, latency, and multiple channel access. It is difficult to address these challenges because there is a trade-off between processing delay and interference/energy efficiency. A conventional AF relay node always amplifies and retransmits received signals, which is not energy-efficient and may cause severe interference to neighboring nodes. In UHR wireless networks, it is contemplated that not only can an access point (AP) function as a relay node, but a station (STA) may also function as a relay node. As such, low-power operation of the relay node is important. Also, it is important to minimize/reduce the amount of interference caused by the relay node to neighboring nodes (e.g., by retransmitting unnecessary, spurious, in-band signals/noise), particularly in dense network situations.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 is a diagram showing a frame exchange sequence for normal (non-relay) operations and relay operations, according to some embodiments.

FIG. 11 is a diagram showing relay functionality being turned on and turned off on a per-PPDU basis, according to some embodiments.

FIG. 12 is a diagram showing a PPDU that includes a guard time to allow sufficient time for activating relay functionality, according to some embodiments.

FIG. 13 is a diagram showing a PPDU that includes a repeated L-SIG (RL-SIG) field for range extension, according to some embodiments.

FIG. 14 is a diagram showing a frame exchange sequence in which per-PPDU relay activation is allowed during a relay operation period, according to some embodiments.

FIG. 15 is a flow diagram of a method performed by a source node for activating relay functionality of a relay node on a per-PPDU basis, according to some embodiments.

FIG. 16 is a flow diagram of a method performed by a relay node for activating relay functionality on a per-PPDU basis, according to some embodiments.

### DETAILED DESCRIPTION

The present disclosure generally relates to wireless communications, and more specifically, relates to activating relay functionality of a relay node on a per physical layer protocol data unit (PPDU) basis.

As mentioned above, a conventional amplify-and-forward (AF) relay node always amplifies and retransmits received signals, which is not energy-efficient and may cause severe interference to neighboring nodes.

The present disclosure describes a technique to activate relay functionality of a relay node on a per-physical layer protocol data unit (PPDU) basis, which may allow for more energy-efficient operation of the relay node and/or reduce the amount of interference to neighboring nodes. New PPDU formats and methods are described herein to enable per-PPDU relay activation. The new PPDU format may include a first set of preamble fields including a first legacy short training field (L-STF) field, a first legacy long training field (L-LTF) field, and a first legacy signal (L-SIG) field to maintain legacy/backwards compatibility. The new PPDU format may further include a “relay-on” field that comes after the first set of preamble field to indicate that the PPDU should be relayed. The new PPDU format may further include a second set of preamble fields that comes after the relay-on field. The second set of preamble fields may include a second L-STF field, a second L-LTF field, and a second L-SIG field. The new PPDU format may further include a data field that includes a frame intended for a destination node. The inclusion of the relay-on field in the PPDU may indicate to a relay node that the remainder of the PPDU that comes after the relay-on field is to be relayed. The first L-SIG field (included in the first set of preamble fields) may be used to spoof relay operations as data to legacy wireless devices that do not support per-PPDU relay activation (to protect the relay operations). The relay-on field may serve to provide a guard time that allows the relay node to activate its relay functionality (turn on its relay functionality) before performing AF relay operations.

According to some embodiments, a source node generates a PPDU that includes a first set of preamble fields, followed by a relay-on field indicating that the relay node should relay the PPDU, followed by a second set of preamble fields, followed by a data field that includes a frame intended for a destination node. The first set of preamble fields may include a first L-STF field, a first L-LTF field, and a first L-SIG field. The second set of preamble fields may include a second L-STF field, a second L-LTF field, and a second L-SIG field. The source node may then transmit the PPDU. A relay node may receive the PPDU and determine whether a relay-on field comes after the first set of preamble fields in the PPDU. Responsive to determining that the relay-on field comes after the first set of preamble fields, the relay node may relay a remainder of the PPDU to the destination node. This relaying may include relaying the second set of preamble fields and the data field included in the PPDU. If the source node wishes to transmit a PPDU that does not need to be relayed, the source node may transmit a normal PPDU that omits the relay-on field. In this way, embodiments allow for activating relay functionality on a per-PPDU basis.

The per-PPDU relay activation technique described herein may provide one or more of the following advantages. First, it may improve the energy-efficiency of the relay node since the relay node does not need to keep its relay functionality turned on all the time but may keep its relay functionality turned off by default and only activate its relay functionality on a per-PPDU basis when needed. This may help extend the battery life of the relay node. Second, it may avoid/reduce unnecessary neighbor node interference caused by the relay node. Since the relay node keeps its relay functionality turned off by default and only activates its relay functionality on a per-PPDU basis as needed, the relay node may avoid retransmitting unnecessary, spurious, in-band signals/noise. This may help improve overall network performance (e.g., lower latency and/or higher throughput). Third, the relay node may be able to transmit and receive its own data when there is no data to relay (in contrast to a conventional relay node which cannot transmit and receive its own data because its relay functionality has to be “always on”), resulting in improved performance. Overall, the per-PPDU relay activation technique provides more flexible and efficient relay operations. After reserving the end-to-end link, physical layer signaling can be used to indicate whether the PPDU should be relayed, resulting in greater latency reduction. While certain advantages are mentioned here, one of ordinary skill in the relevant art will appreciate that the per-PPDU relay activation technique disclosed herein may have other advantages in view of the present disclosure.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and descriptions are to be regarded as illustrative in nature and not restrictive. Like reference numerals designate like elements throughout the specification.

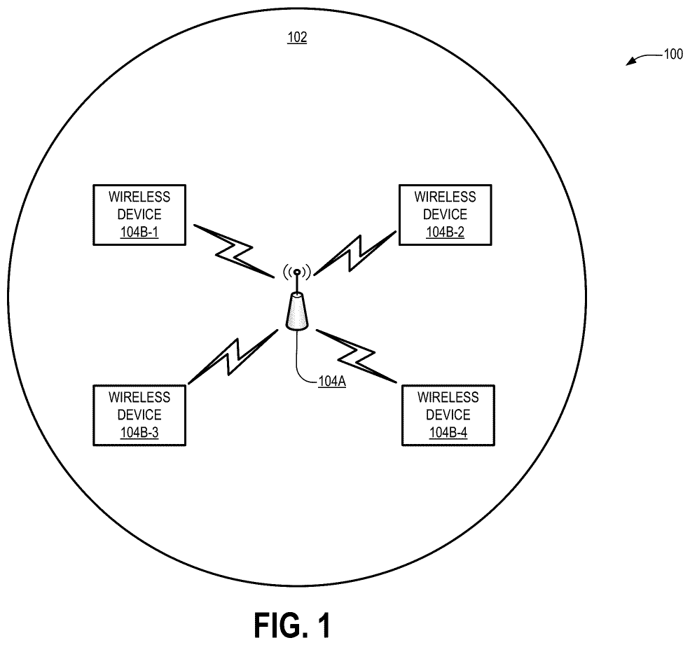

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for ease of description, only the non-AP STAs may be referred to as STAs unless the context indicates otherwise. Although shown with four non-AP STAs (e.g., the wireless devices 104B₁-104B₄), the WLAN 100 may include any number of non-AP STAs (e.g., one or more wireless devices 104B).

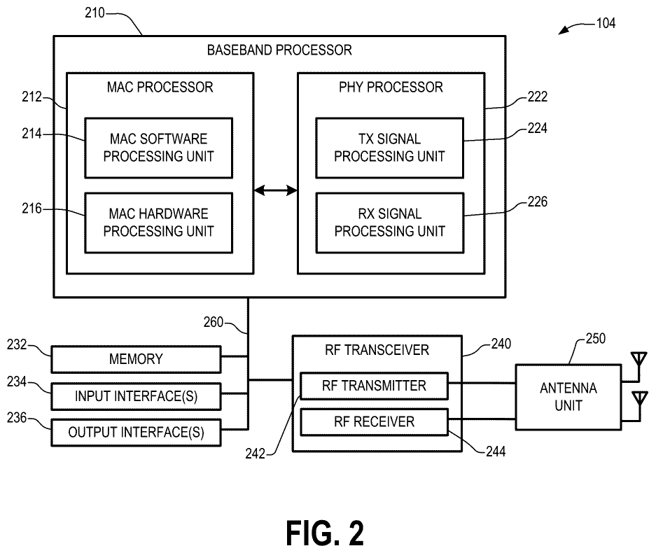

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programming instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more design costs, manufacturing costs, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

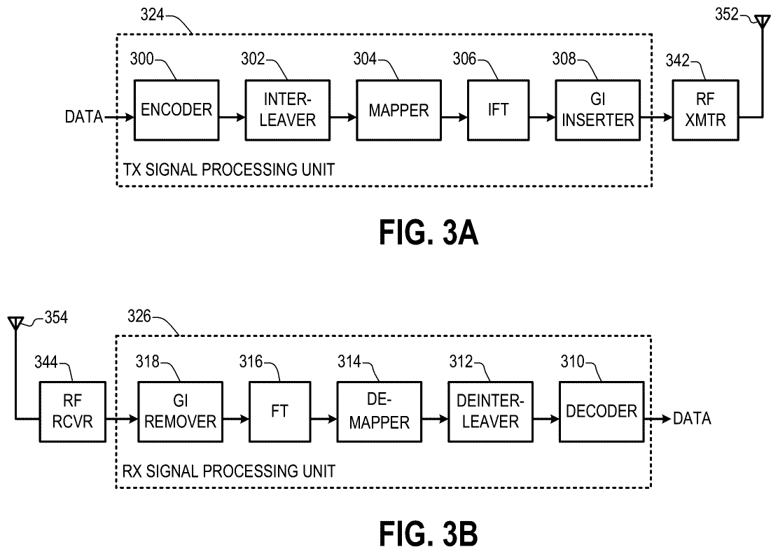

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of Os or 1s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for the sake of completeness and brevity, refer to OFDM-based 802.11 technology. Unless otherwise indicated, a station refers to a non-AP STA.

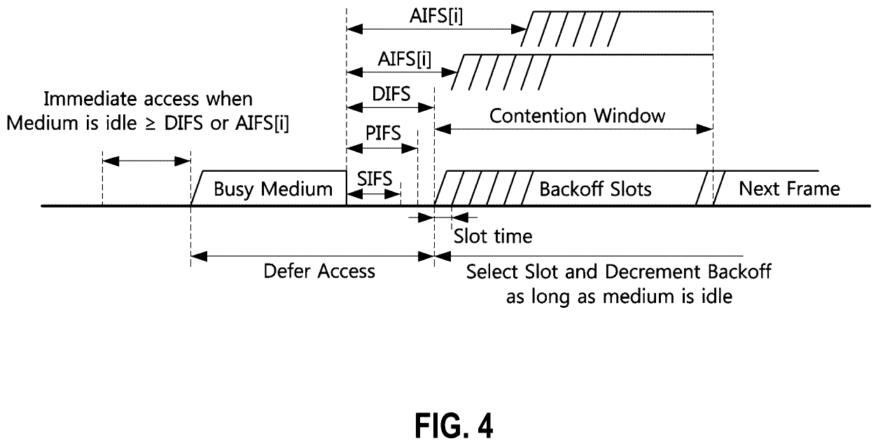

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS [i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QOS) functionality (that is, a QOS STA) may transmit the frame after performing backoff if an AIFS for an associated access category (AC) (i.e., AIFS [AC]) has elapsed. When transmitted by the QoS STA, any of the data frame, the management frame, and the control frame, which is not the response frame, may use the AIFS [AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrease the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

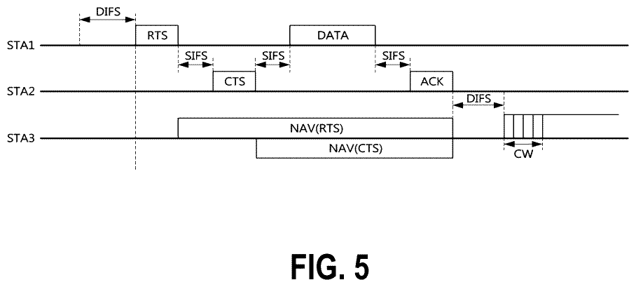

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

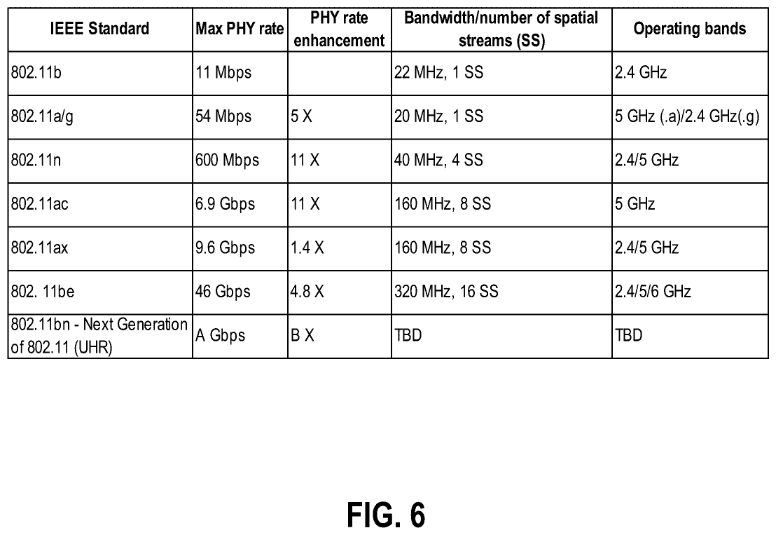

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640 MHz), aggregated PPDU (A-PPDU), enhanced multi-link single-radio (eMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHZ) for IEEE 802.11be, more than 1 GHz of additional unlicensed spectrum is likely to be available because the 6 GHz band (5.925-7.125 GHz) is being considered for unlicensed use. This would allow APs and STAs to become tri-band devices. Larger than 160 MHz data transmissions (e.g., 320 MHz or 640 MHz) could be considered to increase the maximum PHY rate. For example, 320 MHz or 160+160 MHz data could be transmitted in the 6 GHz band. For example, 160+160 MHz data could be transmitted across the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

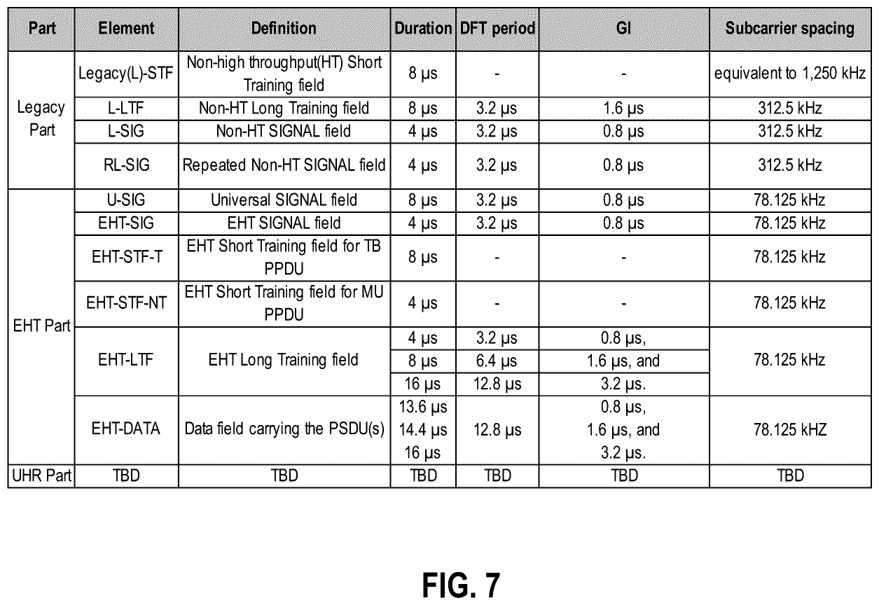

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

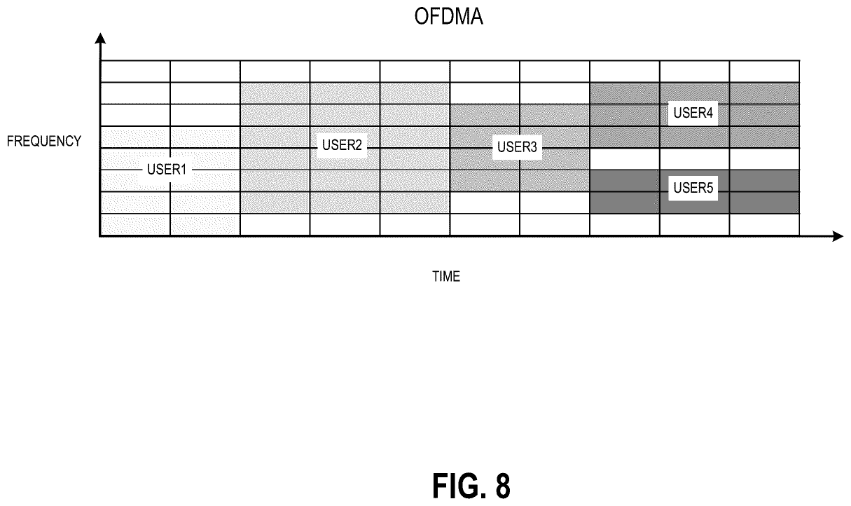

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

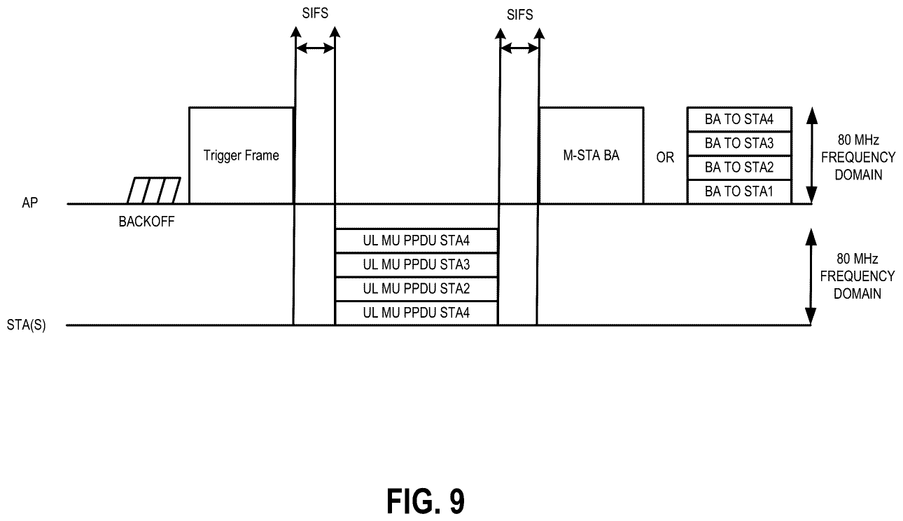

FIG. 9 illustrates an example scenario where an access point (AP) operating in an 80 MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80 MHz width multi-STA Block Acknowledgement (Block Ack) or a Block Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (C-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:

Coordinated Beamforming (C-BF): Multiple APs transmit on the same frequency resource by coordinating and forming spatial nulls, allowing for simultaneous transmission from multiple APs.

Coordinated OFDMA (C-OFDMA): APs transmit on orthogonal frequency resources by coordinating and splitting the spectrum, enabling more efficient spectrum utilization.

Joint Transmission (JTX): Multiple APs transmit jointly to a given user simultaneously by sharing data between the APs.

Coordinated Spatial Reuse (C-SR): Multiple APs or STAs adjust their transmit power to reduce interference between APs.

By implementing these AP coordination schemes, WLAN systems can improve their overall throughput and efficiency by leveraging the cooperation between multiple APs.

As mentioned above, a conventional AF relay node always amplifies and retransmits received signals, which is not energy-efficient and may cause severe interference to neighboring nodes (e.g., by retransmitting unnecessary, spurious, in-band signals/noise). In UHR (IEEE 802.11bn), it is contemplated that not only can an AP function as a relay node, but a STA may also function as a relay node. As such, low-power operation of the relay node is important. Also, it is important to minimize/reduce the amount of interference caused by the relay node to neighboring nodes, particularly in dense network situations.

To address these issues, a technique has been proposed in which a relay node keeps its relay functionality turned off by default and activates its relay functionality for a period of time when requested via control frames.

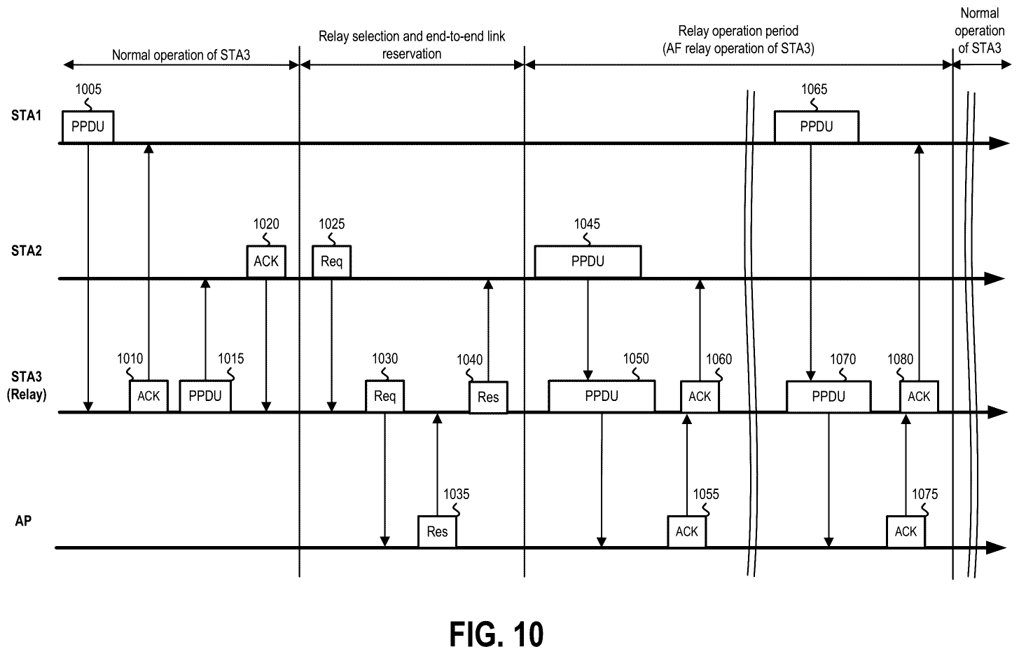

FIG. 10 is a diagram showing a frame exchange sequence for normal (non-relay) operations and relay operations, according to some embodiments. The frame exchange sequence may involve a first STA (STA1), a second STA (STA2), a third STA (STA3), and an AP. In this example, it is assumed that STA3 may function as a relay node to relay frames/data between STA1/STA2 and the AP. STA3 may keep its relay functionality turned off by default and activate its relay functionality when requested. The relay node may keep its relay functionality turned on for a period of time (referred to herein as the relay operation period). While relay functionality of STA3 is turned on, STA3 may relay frames/data. While relay functionality of STA3 is turned off, STA3 may not be able to relay frames/data.

As shown in the diagram, STA3 may initially have its relay functionality turned off and thus perform normal (non-relay) operations. For example, STA1 may transmit PPDU 1005 to STA3. Responsive to receiving PPDU 1005, STA3 may transmit ACK frame 1010 to STA1 to acknowledge successful reception of a frame included in PPDU 1005. STA3 may then transmit PPDU 1015 to STA2. Responsive to receiving PPDU 1015, STA2 may transmit ACK frame 1020 to STA3 to acknowledge successful reception of a frame included in PPDU 1015.

Subsequently, STA2 may transmit request frame (“Req”) 1025 to STA3 to request relay operations. Responsive to receiving request frame 1025, STA3 may transmit request frame 1030 to the AP. Responsive to receiving request frame 1030, the AP may transmit response frame (“Res”) 1035 to STA3. Responsive to receiving response frame 1035, STA3 may transmit response frame 1040 to STA2 and activate its relay functionality (so that it can start relaying frames). The exchange of the request frames and response frames may reserve an end-to-end link for relay operations and start a relay operation period. The relay operation period may last for a predefined length of time.

STA3 may keep its relay functionality turned on and perform relay operations during the relay operation period. For example, if STA2 transmits PPDU 1045, STA3 may relay PPDU 1045 to the AP using an AF relay mechanism by transmitting PPDU 1050 to the AP. The transmission of PPDU 1050 may be an amplified retransmission of PPDU 1045. Responsive to receiving PPDU 1050, the AP may transmit ACK frame 1055 to acknowledge successful reception of a frame included in PPDU 1050 and STA3 may relay ACK frame 1055 to STA2 by transmitting ACK frame 1060 to STA2. The transmission of ACK frame 1060 may be an amplified retransmission of ACK frame 1055. Also, during the relay operation period, if STA1 transmits PPDU 1065, STA3 may relay PPDU 1065 to the AP using an AF relay mechanism by transmitting PPDU 1070 to the AP. The transmission of PPDU 1070 may be an amplified retransmission of PPDU 1065. Responsive to receiving PPDU 1070, the AP may transmit ACK frame 1075 to acknowledge successful reception of a frame included in PPDU 1070 and STA3 may relay ACK frame 1075 to STA1 by transmitting ACK frame 1080 to STA1. The transmission of ACK frame 1080 may be an amplified retransmission of ACK frame 1075.

When the relay operation period ends, STA3 may deactivate its relay functionality and perform normal (non-relay) operations.

By keeping the relay functionality of the relay node (STA3) turned off by default and only activating it during a relay operation period when requested, the energy-efficiency of the relay node is improved and the amount of interference to neighboring nodes is reduced (compared to a situation in which the relay node always keeps its relay functionality turned on). However, this technique is not energy-efficient during the relay operation period and there is still a problem of neighboring node interference during the relay operation period (e.g., since the relay node keeps its relay functionality turned on during the entire relay operation period).

A technique is described herein to activate relay functionality of a relay node on a per-PPDU basis, which may further improve the energy-efficiency of the relay node and/or further reduce the amount of interference to neighboring nodes. Such technique may be referred to herein as a per-PPDU relay activation technique.

A new PPDU format is described herein to enable the per-PPDU relay activation technique. The new PPDU format may include a first set of preamble fields including a first L-STF field, a first L-LTF field, and a first L-SIG field to maintain legacy/backwards compatibility. The new PPDU format may further include a “Relay On” field that comes after the first set of preamble field to indicate that the PPDU should be relayed. The new PPDU format may further include a second set of preamble fields that comes after the relay-on field. The second set of preamble fields may include a second L-STF field, a second L-LTF field, and a second L-SIG field. The new PPDU format may further include a data field that includes a frame intended for a destination node. The inclusion of the relay-on field in the PPDU may indicate to a relay node that the remainder of the PPDU that comes after the relay-on field should be relayed. The first L-SIG field (included in the first set of preamble fields) may be used to spoof relay operations as data to legacy wireless devices that do not support per-PPDU relay activation (so that the legacy wireless devices do not transmit data while the PPDU is being transmitted and relayed). For example, the first L-SIG field may include rate and length information to spoof the relay operations as data. In addition to serving as an indication that the remainder of the PPDU should be relayed, the relay-on field may additionally serve as a guard time that allows the relay node to activate its relay functionality (turn on its relay functionality) before performing AF relay operations. The first L-SIG field (included in the first set of preamble fields) or the relay-on field may indicate which relay node should relay the PPDU (e.g., since there could be multiple potential relay nodes). The relay-on field may include relay on/off information, relay duration information, and/or relay node ID information.

In an embodiment, the relay-on field is transmitted as a L-STF field. A relay node may determine that a received PPDU includes the relay-on field based on detecting that a L-STF field (which is the relay-on field) is transmitted after a first set of preamble fields (e.g., after a L-STF field, L-LTF field, and L-SIG field). In an embodiment, the relay-on field is modulated such that it can be auto-detected by a relay node. For example, the relay-on field may include two symbols, where the first symbol is transmitted using a Q-BPSK modulation scheme and the second symbol is transmitted using a BPSK modulation scheme. In an embodiment, the relay-on field includes a mode indicator indicating whether the PPDU should be relayed or not.

A relay node that receives a PPDU may determine whether the PPDU includes a relay-on field that comes after a first set of preamble fields. If the PPDU does not include the relay-on field, the relay node may refrain from relaying the PPDU. Otherwise, if the PPDU includes the relay-on field, the relay node may activate is relay functionality and relay the remainder of the PPDU to the destination node (e.g., using an AF relay mechanism (e.g., by amplifying and forwarding the remainder of the PPDU)). The remainder of the PPDU may include a second set of preamble fields and a data field that includes a frame intended for the destination node. The second set of preamble fields may include a second L-STF field, a second L-LTF field, and a second L-SIG field. The relay node may keep its relay functionality turned on long enough to also relay the corresponding ACK frame transmitted by the destination node.

Wireless devices that support per-PPDU relay activation may detect the relayed fields that come after the relay-on field and thus receive the second set of preamble fields (e.g., including the second L-STF field, the second L-LTF field, the second L-SIG field) and the data field (e.g., including the data frame). Wireless devices that are located at a close distance from the source node may detect and process the portion of the PPDU that comes before the relay-on field, but wireless devices at a long distance away from the source node may only detect and process the relayed portion of the PPDU (the portion of the PPDU that comes after the relay-on field). Legacy wireless devices that do not support per-PPDU relay activation may recognize the relayed portion as data due to the spoofing provided by the L-SIG field included in the legacy compatible part of the PPDU (the first L-SIG field included in the first set of preamble fields).

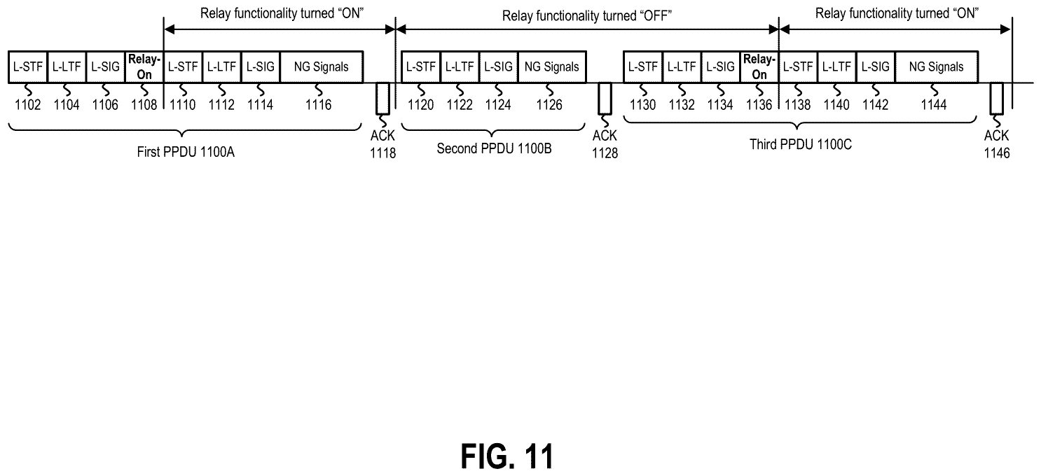

FIG. 11 is a diagram showing relay functionality being turned on and turned off on a per-PPDU basis, according to some embodiments.

As shown in the diagram, a source node may transmit a first PPDU 1100A that is to be relayed. The first PPDU 1100A may include L-STF field 1102, L-LTF field 1104, L-SIG field 1106, relay-on field 1108, L-STF field 1110, L-LTF field 1112, L-SIG field 1114, and NG signals 1116. NG signals 1116 may encode additional fields in accordance with a wireless networking standard. The inclusion of relay-on field 1108 in the first PPDU 1100A may indicate to the relay node that the relay node should relay the remainder of the first PPDU 1100A. When the relay node receives the first PPDU 1100A, it may activate its relay functionality upon detecting relay-on field 1108 in the first PPDU (relay functionality of the relay node is turned on), and relay the remainder of the first PPDU 1100A to the destination node. Responsive to receiving the first PPDU 1100A, the destination node may transmit ACK frame 1118 and the relay node may relay ACK frame 1118 to the source node. The relay node may deactivate its relay functionality after relaying ACK frame 1118.

The source node may then transmit a second PPDU 1100B that is not to be relayed. The second PPDU 1100B may include L-STF field 1120, L-LTF field 1122, L-SIG field 1124, and NG signals 1126. NG signals 1126 may encode additional fields in accordance with a wireless networking standard. Notably, since the second PPDU 1100B is not to be relayed, the second PPDU 1100B does not include a relay-on field. When the relay node receives the second PPDU, it does not detect a relay-on field in the second PPDU, and thus does not activate its relay functionality (relay functionality of the relay node remains turned off). Responsive to receiving the second PPDU 1100B, the relay node may transmit ACK frame 1128 to the source node.

The source node may then transmit a third PPDU 1100B that is to be relayed. Similar to the first PPDU 1100A, the third PPDU 1100B may include L-STF field 1130, L-LTF field 1132, L-SIG field 1134, relay-on field 1136, L-STF field 1138, L-LTF field 1140, L-SIG field 1142, and NG signals 1144. The NG signals 1144 may encode additional fields in accordance with a wireless networking standard. The inclusion of relay-on field 1136 in the third PPDU 1100C may indicate to the relay node that the relay node should relay the remainder of the third PPDU 1100C. When the relay node receives the third PPDU 1100C, it may activate its relay functionality upon detecting relay-on field 1136 in the third PPDU, and relay the remainder of the third PPDU 1100C to the destination node. Responsive to receiving the third PPDU 1100C, the destination node may transmit ACK frame 1146 and the relay node may relay ACK frame 1146 to the source node. The relay node may deactivate its relay functionality after relaying ACK frame 1146.

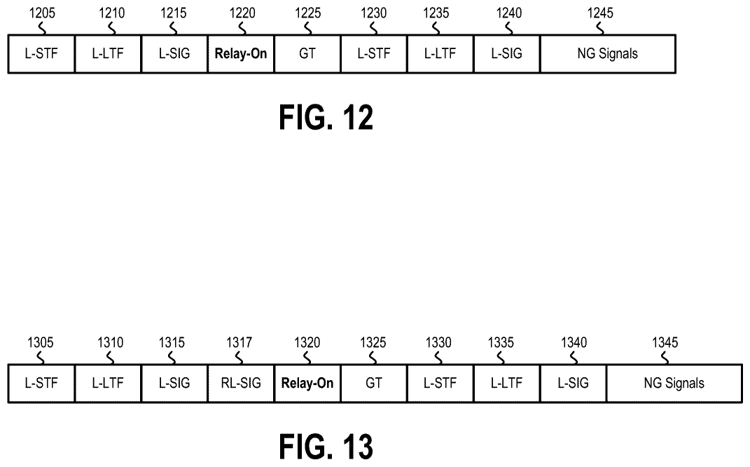

FIG. 12 is a diagram showing a PPDU that includes a guard time to allow sufficient time for activating relay functionality, according to some embodiments.

In an embodiment, a guard time is included between the relay-on field and the following L-STF field to allow sufficient time for the relay node to activate its relay functionality.

For example, as shown in the diagram, the PPDU includes L-STF field 1205, L-LTF field 1210, L-SIG field 1215, relay-on field 1220, guard time 1225, L-STF field 1230, L-LTF field 1235, L-SIG field 1240, and NG (new generation) signals 1245. The inclusion of guard time 1225 between relay-on field 1220 and L-STF field 1130 may provide additional time for the relay node to activate its relay functionality, thereby preventing any performance degradation due to signal distortion during the settling time of the relay node's amplifier. The guard time 1225 thus provides a protection period for the stabilization time of the signal when the relay node amplifies the signal using an AF relay mechanism. The portion of the PPDU that comes after the relay-on field 1220 and the guard time 1225 may be relayed. NG signals 1245 may encode additional fields in accordance with a wireless networking standard.

FIG. 13 is a diagram showing a PPDU that includes a repeated L-SIG (RL-SIG) field for range extension, according to some embodiments.

In an embodiment, a repeated L-SIG (RL-SIG) field is added after the L-SIG field to extend legacy wireless device protection and service coverage. The RL-SIG field may be a repetition of the L-SIG field that comes before it.

For example, as shown in the diagram, the PPDU includes L-STF field 1305, L-LTF field 1310, L-SIG field 1315, RL-SIG field 1317, relay-on field 1320, guard time 1325, L-STF field 1330, L-LTF field 1335, L-SIG field 1340, and NG signals 1345. RL-SIG field 1317 may be a repetition of L-SIG field 1315. The inclusion of RL-SIG field 1317 may extend the legacy wireless device protection and service coverage (e.g., by repeating L-SIG field 1315). L-SIG field 1315 and RL-SIG field 1317 may provide legacy wireless device protection (e.g., by spoofing relay operations as data to legacy wireless devices). The portion of the PPDU that comes after the relay-on field 1320 and guard time 1325 may be relayed. NG signals 1345 may encode additional fields in accordance with a wireless networking standard.

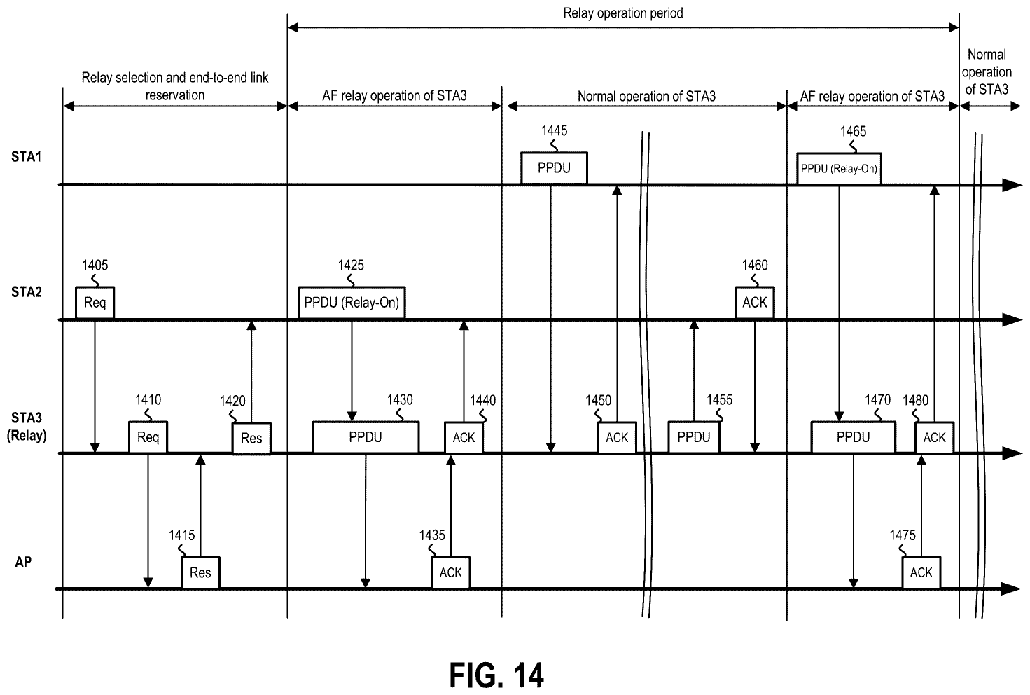

FIG. 14 is a diagram showing a frame exchange sequence in which per-PPDU relay activation is allowed during a relay operation period, according to some embodiments. The frame exchange sequence may involve a first STA (STA1), a second STA (STA2), a third STA (STA3), and an AP. In this example, it is assumed that STA3 can function as a relay node to relay frames/data between STA1/STA2 and the AP. STA3 may keep its relay functionality turned off by default and activate its relay functionality on a per-PPDU basis (depending on whether the PPDU includes a relay-on field or not) during a relay operation period.

As shown in the diagram, STA2 may transmit request frame (“Req”) 1405 to STA3 to request relay operations. Responsive to receiving request frame 1405, STA3 may transmit request frame 1410 to the AP. Responsive to receiving request frame 1410, the AP may transmit response frame (“Res”) 1415 to STA3. Responsive to receiving response frame 1415, STA3 may transmit response frame 1420 to STA2. The exchange of the request frames and response frames may reserve an end-to-end link for relay operations and start a relay operation period.

During the relay operation period, STA3 may activate its relay functionality on a per-PPDU basis depending on whether a PPDU includes a relay-on field or not. For example, STA2 may transmit PPDU 1425 with a relay-on field and STA3 may recognize that PPDU 1425 should be relayed based on detecting the relay-on field in PPDU 1425. Accordingly, STA3 may activate its relay functionality and relay PPDU 1425 to the AP using an AF relay mechanism by transmitting PPDU 1430 to the AP. The transmission of PPDU 1430 may be an amplified retransmission of the portion of PPDU 1425 that comes after the relay-on field. Responsive to receiving PPDU 1430, the AP may transmit ACK frame 1435 to acknowledge successful reception of a frame included in PPDU 1430 and STA3 may relay ACK frame 1435 to STA2 by transmitting ACK frame 1440 to STA2. The transmission of ACK frame 1440 may be an amplified retransmission of ACK frame 1435. The relay node may deactivate its relay functionality after relaying ACK frame 1435 to STA2.

Also, during the relay operation period, STA1 may transmit PPDU 1445 to STA3 that does not include a relay-on field and thus should not be relayed. STA3 may recognize that PPDU 1445 should not be relayed based on not detecting a relay-on field in PPDU 1445. Responsive to receiving PPDU 1445, STA3 may transmit ACK frame 1450 to acknowledge successful reception of a frame included in PPDU 1445. Also, STA3 may transmit PPDU 1455 to STA2. Responsive to receiving PPDU 1455, STA2 may transmit ACK frame 1460 to STA3.

Also, during the relay operation period, STA1 may transmit PPDU 1465 with a relay-on field and STA3 may recognize that PPDU 1465 should be relayed based on detecting the relay-on field in PPDU 1465. Accordingly, STA3 may activate its relay functionality and relay PPDU 1465 to the AP using an AF relay mechanism by transmitting PPDU 1470 to the AP. The transmission of PPDU 1470 may be an amplified retransmission of the portion of PPDU 1465 that comes after the relay-on field. Responsive to receiving PPDU 1470, the AP may transmit ACK frame 1475 to acknowledge successful reception of a frame included in PPDU 1470 and STA3 may relay ACK frame 1475 to STA1 by transmitting ACK frame 1480 to STA1. The transmission of ACK frame 1480 may be an amplified retransmission of ACK frame 1480. The relay node may deactivate its relay functionality after relaying ACK frame 1475 to STA1.

Thus, as shown in this example, both normal (non-relay) operations and relay operations are allowed during the relay operation period.

When the relay operation period ends, STA3 may keep its relay functionality turned off and may not be allowed to activate its relay functionality, and thus STA3 may perform normal (non-relay) operations only.

Per-PPDU relay activation can be performed after the end-to-end link is reserved as shown in FIG. 14. In this case, a relay operation period is reserved and relay functionality of the relay node (STA3) may be activated on a per-PPDU basis during the relay operation period. In an embodiment, as shown in the diagram, the relay node (STA3) is allowed to perform normal (non-relay) operations during the relay operation period.

While the per-PPDU relay activation technique has been primarily described herein in a context in which the relay node is an AF relay node, the per-PPDU relay technique may also be applied to a context in which the relay node is a DF relay node.

The per-PPDU relay activation technique described herein may provide one or more of the following advantages. First, it may improve the energy-efficiency of the relay node since the relay node does not need to keep its relay functionality turned on all the time but may keep its relay functionality turned off by default and only activate its relay functionality on a per-PPDU basis when needed. This may help extend the battery life of the relay node. Second, it may avoid/reduce unnecessary neighbor node interference caused by the relay node. Since the relay node keeps its relay functionality turned off by default and only activates its relay functionality on a per-PPDU basis as needed, the relay node may avoid retransmitting unnecessary, spurious, in-band signals/noise. This may help improve overall network performance (e.g., lower latency and/or higher throughput). Third, the relay node may be able to transmit and receive its own data when there is no data to relay (in contrast to a conventional relay node which cannot transmit and receive its own data because its relay functionality has to be “always on”), resulting in improved performance. Overall, the per-PPDU relay activation technique provides more flexible and efficient relay operations. After reserving the end-to-end link, physical layer signaling can be used to indicate whether the PPDU should be relayed, resulting in greater latency reduction. While certain advantages are mentioned here, one of ordinary skill in the relevant art will appreciate that the technique disclosed herein may have other advantages in view of the present disclosure.

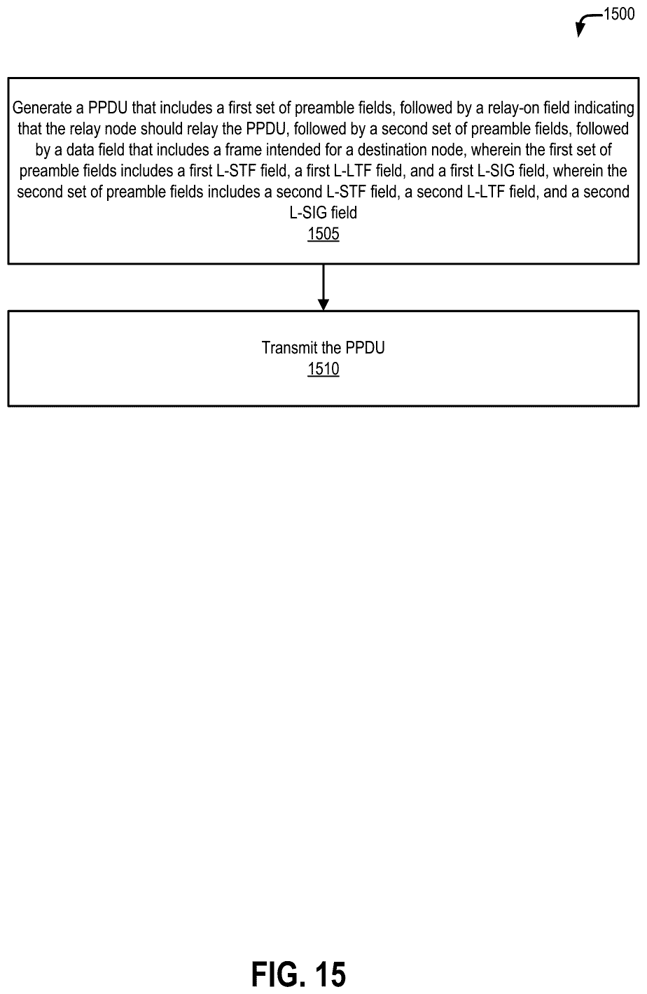

Turning now to FIG. 15, a method 1500 will be described for activating relay functionality of a relay node on a per-PPDU basis, in accordance with an example embodiment. The method 1500 may be performed by a source node that wishes transmit a PPDU to a destination node. The source node may be a wireless device (e.g., wireless device 104).

Additionally, although shown in a particular order, in some embodiments the operations of the method 1500 (and the other methods shown in the other figures) may be performed in a different order. For example, although the operations of the method 1500 are shown in a sequential order, some of the operations may be performed in partially or entirely overlapping time periods.

At operation 1505, the source node generates a PPDU that includes a first set of preamble fields, followed by a relay-on field indicating that the relay node should relay the PPDU, followed by a second set of preamble fields, followed by a data field that includes a frame intended for a destination node, wherein the first set of preamble fields includes a first L-STF field, a first L-LTF field, and a first L-SIG field, wherein the second set of preamble fields includes a second L-STF field, a second L-LTF field, and a second L-SIG field.

At operation 1510, the source node transmits the PPDU.

In an embodiment, the source node receives an ACK frame that corresponds to the frame included in the data field, wherein the ACK frame was transmitted by the destination node and relayed by the relay node to the source node.

In an embodiment, the PPDU includes a guard time between the relay-on field and the second set of preamble fields. In an embodiment, the first set of preamble fields further includes a repeated legacy signal (RL-SIG) field. In an embodiment, the first L-SIG field is used to spoof relay operations as data to legacy wireless devices that do not support per-PPDU relay activation.

In an embodiment, the PPDU is transmitted during a relay operation period during which relay operations are allowed. In an embodiment, during the relay operation period, the source node transmits a second PPDU that does not include a relay-on field and that is not to be relayed.

In an embodiment, the relay-on field is modulated such that the relay-on field can be auto-detected by a relay node. For example, in an embodiment, the relay-on field includes a first symbol and a second symbol, wherein the first symbol is modulated using a Q-BPSK modulation scheme and the second symbol is modulated using a BPSK modulation scheme.

In an embodiment, the relay-on field is transmitted as a L-STF field.

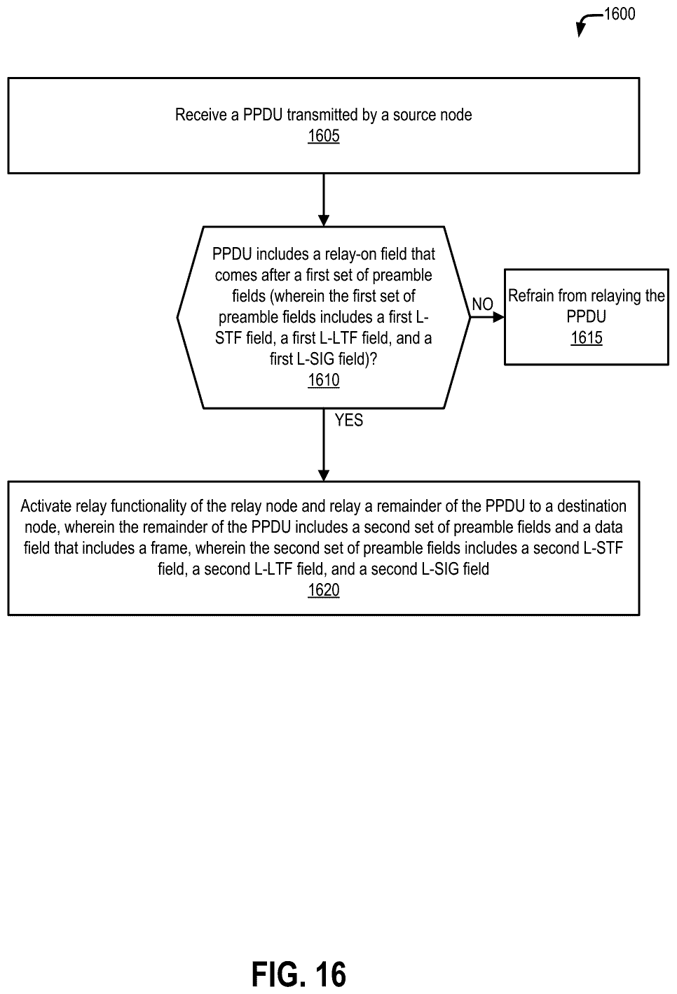

Turning now to FIG. 16, a method 1600 will be described for activating relay functionality on a per-PPDU basis, in accordance with an example embodiment. The method 1600 may be performed by a relay node that is to act as a relay between a source node and a destination node. The relay node may be a wireless device (e.g., wireless device 104).

At operation 1605, the relay node receives a PPDU transmitted by the source node.

At operation 1610, the relay node determines whether the PPDU includes a relay-on field that comes after a first set of preamble fields, wherein the first set of preamble fields includes a first L-STF field, a first L-LTF field, and a first L-SIG field. If the PPDU does not include the relay-on field that comes after the first set of preamble fields, the flow may proceed to operation 1615 at which the relay node refrains from relaying the PPDU. Otherwise, if the PPDU includes the relay-on field that comes after the first set of preamble fields, the flow may proceed to operation 1620.

At operation 1620, the relay node activates relay functionality of the relay node and relays a remainder of the PPDU to the destination node, wherein the remainder of the PPDU includes a second set of preamble fields and a data field that includes a frame, wherein the second set of preamble fields includes a second L-STF field, a second L-LTF field, and a second L-SIG field.

In an embodiment, the relay node relays an ACK frame, which was transmitted by the destination node and corresponds to the frame included in the data field, to the source node. In an embodiment, the relay node may deactivate the relay functionality of the relay node after relaying the ACK frame.

In an embodiment, the PPDU includes a guard time between the relay-on field and the second set of preamble fields. In an embodiment, the first set of preamble fields further includes a RL-SIG field.

In an embodiment, the PPDU is transmitted during a relay operation period during which relay operations are allowed. In an embodiment, during the relay operation, the relay node receives a second PPDU. The relay node may determine whether the second PPDU includes a second relay-on field that comes after a third set of preamble fields, wherein the third set of preamble fields includes a third L-STF field, a third L-LTF field, and a third L-SIG field. Responsive to determining that the second PPDU does not include the second relay-on field that comes after the third set of preamble fields, the relay node may refrain from relaying the PPDU.

In an embodiment, the determination that the PPDU includes the relay-on field is based on auto-detecting the relay-on field. In an embodiment, the auto-detection of the relay-on field is based on determining that a first symbol included in the relay-on field is modulated using a Q-BPSK modulation scheme and a second symbol included in the relay-on field is modulated using a BPSK modulation scheme.

In an embodiment, the determination that the PPDU includes the relay-on field is based on detecting a L-STF field that comes after the first set of preamble fields, wherein the detected L-STF field is considered as being the relay-on field.

In an embodiment, the remainder of the PPDU is relayed using an AF relay mechanism. In an embodiment, the remainder of the PPDU is relayed using a DF relay mechanism.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a source node to activate relay functionality of a relay node on a per-physical layer protocol data unit (PPDU) basis, the method comprising:
generating a PPDU that includes a first set of preamble fields, followed by a relay-on field indicating that the relay node should relay the PPDU, followed by a second set of preamble fields, followed by a data field that includes a frame intended for a destination node, wherein the first set of preamble fields includes a first legacy short training field (L-STF) field, a first legacy long training field (L-LTF) field, and a first legacy signal (L-SIG) field, wherein the second set of preamble fields includes a second L-STF field, a second L-LTF field, and a second L-SIG field; and
transmitting the PPDU.

2. The method of claim 1, wherein the PPDU includes a guard time between the relay-on field and the second set of preamble fields.

3. The method of claim 1, wherein the first set of preamble fields further includes a repeated legacy signal (RL-SIG) field.

4. The method of claim 1, wherein the PPDU is transmitted during a relay operation period during which relay operations are allowed.

5. The method of claim 4, further comprising:
during the relay operation period, transmitting a second PPDU that does not include a relay-on field and that is not to be relayed.

6. The method of claim 1, wherein the first L-SIG field is used to spoof relay operations as data to legacy wireless devices that do not support per-PPDU relay activation.

7. The method of claim 1, further comprising:
receiving an acknowledgement (ACK) frame that corresponds to the frame included in the data field, wherein the ACK frame was transmitted by the destination node and relayed by the relay node to the source node.

8. The method of claim 1, wherein the relay-on field is modulated such that the relay-on field can be auto-detected by a relay node.

9. The method of claim 8, wherein the relay-on field includes a first symbol and a second symbol, wherein the first symbol is modulated using a quadrature binary phase shift keying (Q-BPSK) modulation scheme and the second symbol is modulated using a binary phase shift keying (BPSK) modulation scheme.

10. The method of claim 1, wherein the relay-on field is transmitted as a L-STF field.

11. A method performed by a relay node to activate relay functionality on a per-physical layer protocol data unit (PPDU) basis, the method comprising:
receiving a PPDU transmitted by a source node;
determining whether the PPDU includes a relay-on field that comes after a first set of preamble fields, wherein the first set of preamble fields includes a first legacy short training field (L-STF) field, a first legacy long training field (L-LTF) field, and a first legacy signal (L-SIG) field; and
responsive to determining that the PPDU includes the relay-on field that comes after the first set of preamble fields, activating relay functionality of the relay node and relaying a remainder of the PPDU to a destination node, wherein the remainder of the PPDU includes a second set of preamble fields and a data field that includes a frame, wherein the second set of preamble fields includes a second L-STF field, a second L-LTF field, and a second L-SIG field.

12. The method of claim 11, wherein the PPDU includes a guard time between the relay-on field and the second set of preamble fields.

13. The method of claim 11, wherein the first set of preamble fields further includes a repeated legacy signal (RL-SIG) field.

14. The method of claim 11, wherein the PPDU is transmitted during a relay operation period during which relay operations are allowed.

15. The method of claim 14, further comprising:
during the relay operation period, receiving a second PPDU;
determining whether the second PPDU includes a second relay-on field that comes after a third set of preamble fields, wherein the third set of preamble fields includes a third L-STF field, a third L-LTF field, and a third L-SIG field; and
responsive to determining that the second PPDU does not include the second relay-on field that comes after the third set of preamble fields, refraining from relaying the PPDU.

16. The method of claim 11, further comprising:
relaying an acknowledgement (ACK) frame, which was transmitted by the destination node and corresponds to the frame included in the data field, to the source node.

17. The method of claim 11, wherein the determination that the PPDU includes the relay-on field is based on auto-detecting the relay-on field.

18. The method of claim 17, wherein the auto-detection of the relay-on field is based on determining that a first symbol included in the relay-on field is modulated using a quadrature binary phase shift keying (Q-BPSK) modulation scheme and a second symbol included in the relay-on field is modulated using a binary phase shift keying (BPSK) modulation scheme.

19. The method of claim 11, wherein the determination that the PPDU includes the relay-on field is based on detecting a L-STF field that comes after the first set of preamble fields, wherein the detected L-STF field is considered as being the relay-on field.

20. The method of claim 11, wherein the remainder of the PPDU is relayed using an amplify and forward (AF) relay mechanism.
